(19) United States
(12) Patent Application Publication
(10) Pub. No.: US 2022/0344866 A1
(43) Pub. Date: Oct. 27, 2022

(54) CONNECTOR APPARATUS WITH SWITCH FOR IMPROVING CONTACT RELIABILITY

(71) Applicant: UJU ELECTRONICS CO., LTD., Hwaseong-si (KR)

(72) Inventor: Jung-Kyu HWANG, Hwaseong-si (KR)

(73) Assignee: UJU ELECTRONICS CO., LTD., Hwaseong-si (KR)

(21) Appl. No.: 17/718,000

(22) Filed: Apr. 11, 2022

(30) Foreign Application Priority Data
Apr. 21, 2021 (KR) 10-2021-0051725

(51) Int. Cl. H01R 13/629; H01R 13/641; H01R 13/627; H01R 13/639

(52) U.S. Cl. CPC H01R 13/629; H01R 13/641; H01R 13/6272; H01R 13/639

(57) ABSTRACT

Proposed is a connector apparatus with a switch for improving contact reliability, the connector apparatus being capable of enabling an operator to electrically test proper coupling of a connector position assurance member. When the connector position assurance member is completely coupled to a first housing, a pair of switches are stably brought into contact with each other in a state of being inserted into a switch guide recess formed in a second leg portion. Therefore, the pair of switches can be safely protected from foreign substances, etc., thereby improving the contact reliability of the first and second switches.

### CROSS REFERENCE TO RELATED APPLICATION

The present application claims priority to Korean Patent Application No. 10-2021-0051725, filed Apr. 21, 2021, the entire contents of which is incorporated herein for all purposes by this reference.

### BACKGROUND OF THE INVENTION

### Field of the Invention

The present disclosure relates generally to a connector apparatus with a switch for improving contact reliability. More particularly, the present disclosure relates to a connector apparatus with a switch for improving contact reliability, the connector apparatus being capable of enabling an operator to electrically test proper coupling of a connector position assurance member.

### Description of the Related Art

Automobiles are assembled under very complex environments and used under extreme environments where various impacts continuously occur. In such environments, it is very important to prevent electrical and mechanical engagement from being released due to improper mating of connector apparatuses applied to automobiles. For example, in the case of safety-related electrical components such as airbags, high reliability of the connector apparatuses is required. To meet this demand, when a first connector and a second connector are mated, a connector position assurance (CPA) is applied to ensure that the first and second connectors are properly mated, thereby ensuring the contact position of the first and second connectors

FIG. 1 is a view illustrating a connector assembly with a conventional connector position assurance device, and FIG. 2 is a view illustrating the conventional connector position assurance device.

Referring to FIGS. 1 and 2, the connector assembly with the conventional connector position assurance device includes a first connector 10, a second connector 20, and the connector position assurance 30.

The first connector 10 is configured as a receptacle connector mounted on a wiring substrate S, and the second connector 20 is configured as a plug connector electrically connected to an electric wire W and inserted into the first connector 10. The connector position assurance device 30 functions as a CPA, and includes has a slide member base 31, a main aim 32 protruding from the center of the slide member base 31, and a pair of support arms 34R and 34L protruding from opposite sides of the slide member base 31. The main arm 32 is brought into contact with and locked to a fitting locking portion (not illustrated) inside the second connector 20. The support arms 34R and 34L function to guide the sliding of the slide member base 31, and are locked to an anti-reverse insertion rib (not illustrated) inside the second connector 20. After the first and second connectors 10 and 20 are mated, the main arm 32 of the connector position assurance device 30 is coupled to a fitting locking portion functioning as a lock lever so as to prevent the first and second connectors 10 and 20 from being arbitrarily separated from each other, thereby preventing the first and second connectors 10 and 20 from being unintentionally disengaged from each other.

Meanwhile, as described above, the connector position assurance device 30 is provided with the pair of support arms 34R and 34L on the opposite sides of the slide member base 31 to guide the sliding of the slide member base 31. This, however, causes the overall width to be increased as much as the width of the pair of support arms 34R and 34L, resulting in a problem of increasing the sizes of the first and second connectors 10 and 20.

In addition, the connector position assurance device 30 is mechanically provided to prevent the disengagement of the first and second connectors 10 and 20, but it is difficult to electrically check whether the connector position assurance device 30 is properly coupled to the first and second connectors 10 and 20. Therefore, there is a problem in that an operator has to frequently check the assembly process whether the connector position assurance device 30 is properly coupled to the first and second connectors 10 and 20.

The foregoing is intended merely to aid in the understanding of the background of the present disclosure, and is not intended to mean that the present disclosure falls within the purview of the related art that is already known to those skilled in the art.

### DOCUMENTS OF RELATED ART

(Patent document 1) Korean Patent No. 10-1886959

### SUMMARY

Accordingly, the present disclosure has been made keeping in mind the above problems occurring in the related art, and an objective of the present disclosure provides a connector apparatus with a switch for improving contact reliability, the connector apparatus being capable of enabling an operator to electrically test proper coupling of a connector position assurance member.

In order to achieve the above objective, according to one aspect of the present disclosure, there is provided a connector apparatus with a switch for improving contact reliability, the connector apparatus including: a first connector including a first housing having an insertion portion concavely formed at a first side thereof and a plurality of first guide portions formed through a second side of the first housing in the direction of the insertion portion, wherein among the plurality of first guide portions, any one first guide portion may be a contact guide portion, the remaining first guide portion except for the contact guide portion may be a first terminal guide portion configured to allow the first terminal to be inserted therein, and a coupling portion may be formed to protrude from an inner surface of the insertion portion; a pair of switches configured to be respectively inserted through a pair of contact guide portions; a second connector inserted into the insertion portion, and including a second housing having a plurality of second guide portions therein and an elastic lever protruding in a cantilever shape from a surface of the second housing so as to have elasticity, wherein among the second guide portions, a second guide portion facing the pair of contact guide portions may be a sliding guide portion, the remaining second guide portion facing the first terminal guide portion may be a second terminal guide portion configured to allow the second terminal to be inserted therein, and the elastic lever may be elastically deformed and locked to the coupling portion when the second housing is inserted into the insertion portion; and a connector position assurance member including a first leg portion inserted into a locking space portion between the second housing and the elastic lever so as to prevent the elastic lever locked to the coupling portion from being elastically deformed, a head portion famed at an outer side of the first leg portion, and a second leg portion having a first side connected to the head portion and a second side inserted into the sliding guide portion. A switch guide recess may be formed at an end of the second leg portion so that when the second leg portion is inserted into the sliding guide portion, the first and second switches are guided and brought into contact with each other.

Furthermore, the pair of contact guide portions may be composed of a first contact guide portion and a second contact guide portion, the pair of switches may be composed of a first switch and a second switch respectively passing through the first contact guide portion and the second contact guide portion and positioned to be spaced apart from each other, the switch guide recess may be formed so that the separation distance between inner opposite sides thereof gradually decreases as the distance from the contact guide portions increases, and when the first switch and the second switch are guided to the switch guide recess, the first switch and the second switch may be brought into contact with each other as the first switch or the second switch is slid along a side portion of the switch guide recess.

Furthermore, the switch guide recess may include a receiving portion having an internal space configured to allow the first and second switches to be guided therein, and a receiving side wall portion formed at a side of the receiving portion, the receiving side wall portion may include a contact guide wall portion positioned at an inner side of the receiving portion and a sliding inclined portion positioned at an outer side of the receiving portion and formed inclinedly, the first switch may be linearly formed to pass through the first contact guide portion, the second switch may be formed to pass through the second contact guide portion and may include an inclined portion inclined in the direction of the first switch in a state of and an extension portion extending in parallel to the first switch from an end of the inclined portion, the first switch and the extension portion may be positioned to be spaced apart from each other before the first switch and the second switch are inserted into the switch guide recess, and when the first switch and the second switch are inserted into the switch guide recess, the extension portion may be slid along the sliding inclined portion and then moved in the direction of the first switch, so that the extension portion and the first switch may be brought into surface contact with each other.

Furthermore, a convex contact portion may be formed at an end of the extension portion to be convex in the opposite direction of the first switch. When the extension portion is moved in the direction of the first switch, the convex contact portion may be elastically deformed in the direction of the first switch in a state of being in contact with the contact guide wall portion, so that the convex contact portion may maintain an electrical contact state between the extension portion and the first switch.

Furthermore, a switch receiving recess may be concavely formed at an inner side of the insertion portion at a position facing the sliding guide portion. The first contact guide portion and the second contact guide portion may be formed through the switch receiving recess, and the inclined portion may be configured to be elastically deformable in a state of being received in the switch receiving recess.

Furthermore, the first switch may include a first switch insertion portion inserted into the first contact guide portion and a contact portion extending linearly from the first switch insertion portion, wherein a first locking protrusion may be formed to protrude from each of longitudinal opposite sides of the first switch insertion portion so as to be locked to an inner periphery of the first contact guide portion, and the second switch may further include a second switch insertion portion having a first side connected to the inclined portion and a second side inserted into the second contact guide portion, wherein a second locking protrusion may be formed to protrude from each of longitudinal opposite sides of the second switch insertion portion so as to be locked to an inner periphery of the second contact guide portion.

Furthermore, a position guide portion may be formed at each of opposite sides of the second leg portion, and a locking guide portion may be famed at each of opposite sides of the sliding guide portion so as to allow the position guide portion to be locked thereto in a state in which the second leg portion is partially inserted into the sliding guide portion.

According to the present disclosure, when the connector position assurance member is completely coupled to the first housing, the pair of switches are stably brought into contact with each other in a state of being inserted into the switch guide recess formed in the second leg portion. Therefore, the pair of switches can be safely protected from foreign substances, etc., thereby improving the contact reliability of the first and second switches.

In addition, the extension portion and the first switch are brought into surface contact with each other and thus have a wide contact area. Therefore, even if foreign substances such as small dust are caught between the extension portion and the first switch, the extension portion and the first switch can stably maintain the contact state, thereby further improving the contact reliability.

In addition, when the extension portion is moved in the direction of the first switch, the convex contact portion is elastically deformed in the direction of the first switch in a state of being in contact with the contact guide wall portion. Therefore, the convex contact portion can stably maintain the electrical contact state between the extension portion and the first switch.

In addition, while the second switch is moved to be brought into contact with the first switch, the switch receiving recess provides a space for allowing the inclined portion to be elastically deformed therein. Therefore, the inclined portion can be easily elastically deformed.

In addition, the first and second locking protrusions are locked to the first and second contact guide portions. Therefore, even if external pressure is applied to the first and second switches, the first and second switches can be firmly secured to the first and second contact guide portions.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating a connector assembly with a conventional connector position assurance device;

FIG. 2 is a view illustrating the conventional connector position assurance device;

FIG. 3 is an exploded view illustrating the connector apparatus with the switch for improving contact reliability according to the exemplary embodiment of the present disclosure;

FIG. 4 is a view illustrating a state in which a connector position assurance member is being inserted into a second housing of the connector apparatus with the switch for improving contact reliability according to the exemplary embodiment of the present disclosure;

FIG. 5 is a sectional view illustrating a state in which the connector position assurance member is primarily inserted and a terminal position assurance member is mounted to the second housing of the connector apparatus with the switch for improving contact reliability according to the exemplary embodiment of the present disclosure;

FIG. 6 is a partially cut view illustrating a first housing of the connector apparatus with the switch for improving contact reliability according to the exemplary embodiment of the present disclosure;

FIG. 7 is a view illustrating the switch of the connector apparatus with the switch for improving contact reliability according to the exemplary embodiment of the present disclosure;

FIG. 8 is a sectional view illustrating a state in which the switch of the connector apparatus with the switch for improving contact reliability according to the exemplary embodiment of the present disclosure is coupled to the first housing;

FIG. 9 is a view schematically illustrating an off state of the switch of the connector apparatus with the switch for improving contact reliability according to the exemplary embodiment of the present disclosure;

FIG. 10 is a sectional view illustrating an off state of the switch of the connector apparatus with the switch for improving contact reliability according to the exemplary embodiment of the present disclosure;

FIG. 11 is a view schematically illustrating an on state of the switch of the connector apparatus with the switch for improving contact reliability according to the exemplary embodiment of the present disclosure; and

FIG. 12 is a sectional view illustrating an on state of the switch of the connector apparatus with the switch for improving contact reliability according to the exemplary embodiment of the present disclosure.

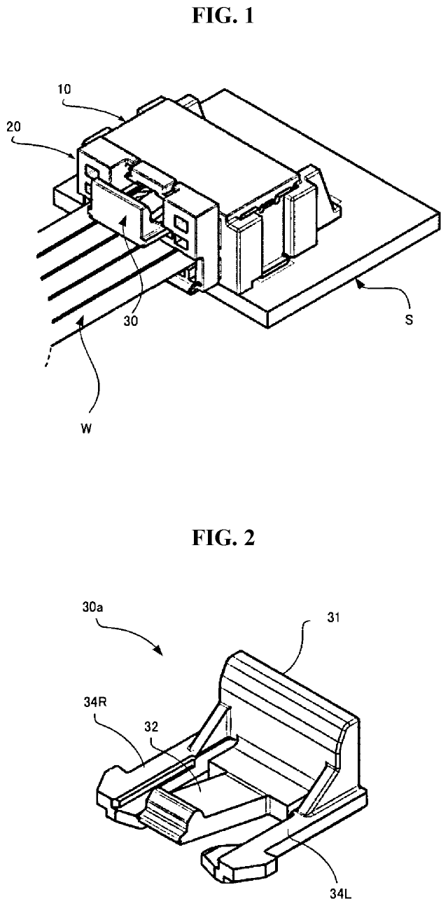

### DETAILED DESCRIPTION

Hereinafter, a connector apparatus with a switch for improving contact reliability according to an exemplary embodiment of the present disclosure will be described in more detail with reference to the accompanying drawings.

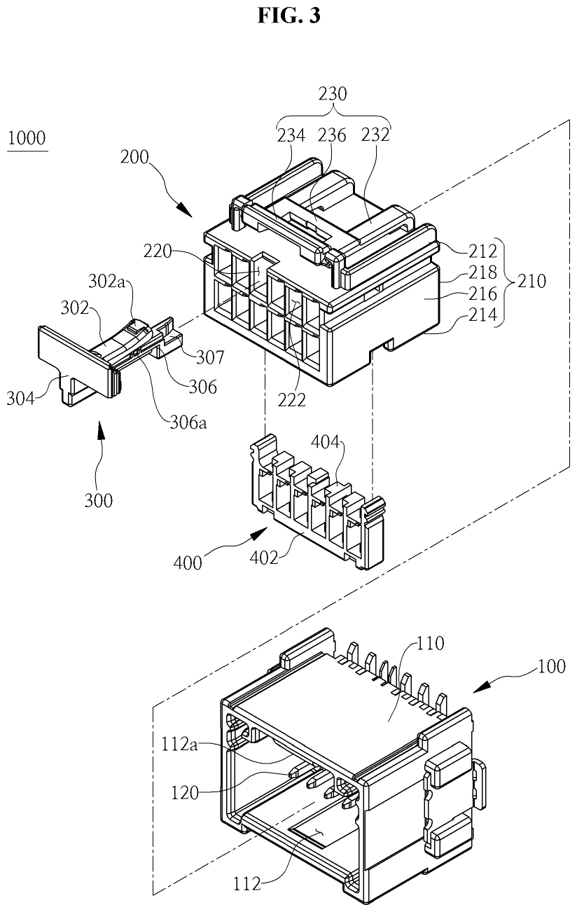

FIG. 3 is an exploded view illustrating the connector apparatus with the switch for improving contact reliability according to the exemplary embodiment of the present disclosure.

Referring to FIG. 3, the connector apparatus 1000 with the switch for improving contact reliability according to the exemplary embodiment of the present disclosure may be used in electric parts of automobiles or in various electronic industries, and may be applied to connect a wire and a wire or a wire and a board. The connector apparatus 1000 with the switch for improving contact reliability includes a first connector 100, a second connector 200, a connector position assurance member 300, a terminal position assurance member 400, and a switch 150.

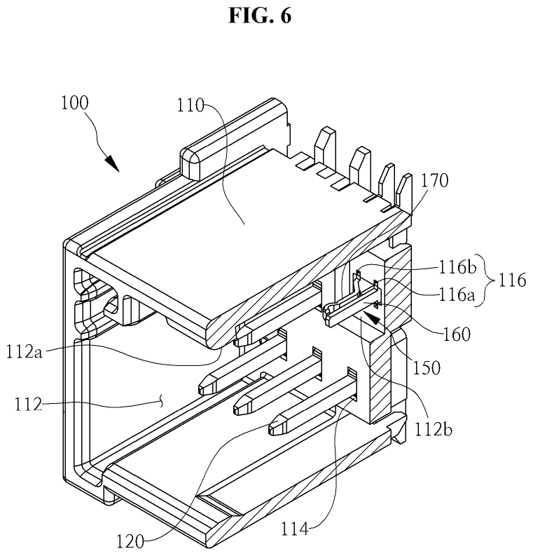

The first connector 100 includes a first housing 110 and a first terminal 120. The first housing 110 is formed, for example, in a substantially hexahedral shape, and includes an insertion portion 112 concavely formed at a first side of the first housing 110 and a plurality of first guide portions formed through a second side of the first housing 110 in the direction of the insertion portion 112. Among the plurality of first guide portions, any one first guide portion is a contact guide portion 116 (illustrated in FIG. 6), and the remaining first guide portion except for the contact guide portion 116 is a first terminal guide portion 114 (illustrated in FIG. 6) allowing the first terminal 120 to be inserted therein. For example, a plurality of first terminal guide portions 114 may be formed through the second side of the first housing 110 along the longitudinal direction, and the contact guide portion 116 may be formed near the center of the second side of the first housing 110 in the longitudinal direction. The first terminal guide portions 114 may be configured in a plurality of columns depending on the number of the first terminal 120. A coupling portion 112a is formed to protrude from the center of an inner upper surface of the insertion portion 112.

The first terminal 120 is formed in a known pin shape, and is inserted into an associated one of the first terminal guide portions 114, with a first side electrically coupled to a second terminal (not illustrated), which will be described later, mounted to the second housing 210, and a second side coupled to a board of electrical components.

The second connector 200 includes a second housing 210, an elastic lever 230, and the second terminal (not illustrated). The second housing 210 is foamed in a substantially hexahedral shape to be inserted into the insertion portion 112, and includes first surface portion 212, a second surface portion 214 spaced apart to face the first surface portion 212, a pair of side wall portions 216 connecting opposite sides of the first surface portion 212 to opposite sides of the second surface portion 214, and a side end portion 218 connecting an end of the first surface portion 212 to an end of the second surface portion 214. In addition, a plurality of second guide portions are internally arranged in parallel between the first surface portion 212 and the second surface portion 214. Among the second guide portions, any one second guide portion is a sliding guide portion 220, and the remaining second guide portion except for the sliding guide portion 220 is a second terminal guide portion 222 facing the first terminal guide portion 114. Here, the sliding guide portion 220 is positioned to face the contact guide portion 116.

The elastic lever 230 is formed to protrude in a cantilever shape so as to have elasticity, and includes a pair of lever portions 232 extending from the center of a front end of the first surface portion 212 in the direction of a rear end of the first surface portion 212 to face each other, a first locking connection portion 234 connecting front ends of the pair of lever portions 232 to each other, and a second locking connection portion 236 connecting the pair of lever portions 232 to each other in a state of being spaced rearwardly apart from the first locking connection portion 234. In addition, a first locking space portion 234a is formed in a space between the first locking connection portion 234 and a rear side of the pair of lever portions 232, and a second locking space portion 236a is formed in a space between the second locking connection portion 236 and a front side of the pair of lever portions 232. Unless otherwise specified in the embodiment of the present disclosure, a portion located close to the side end portion 218 is a front side or front end, and a portion distant from the side end portion 218 is a rear side or rear end.

The second terminal is a conventional configuration that is inserted into an associated one of the second terminal guide portions 222 and electrically connected to an associated one of the respective first terminals 120, and may include, for example, a pin, a wire, etc.

connected to the outside.

A description will be given hereinafter of the connector position assurance member 300, the terminal position assurance member 400, and the switch 150.

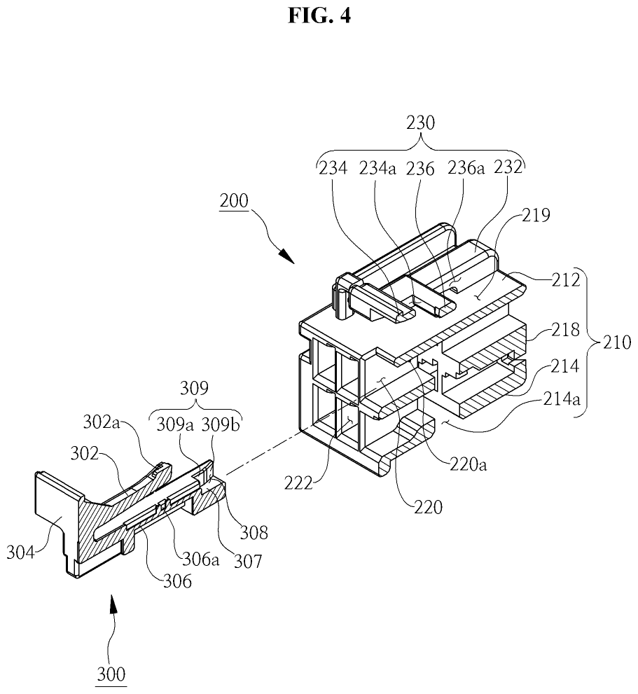

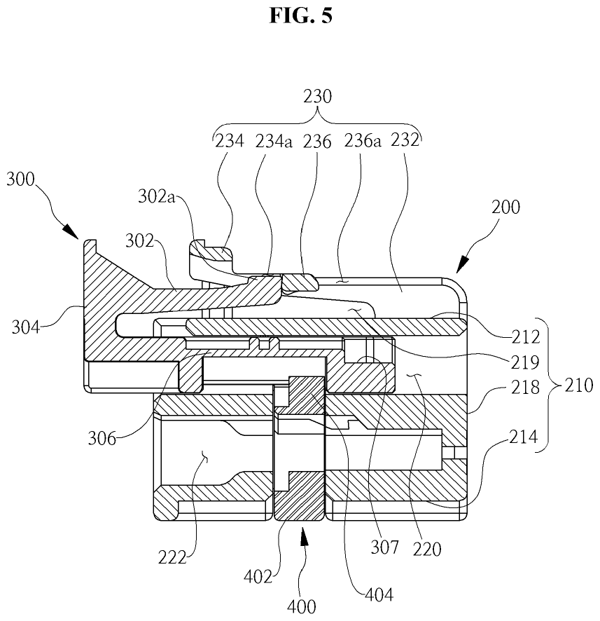

FIG. 4 is a view illustrating a state in which the connector position assurance member is being inserted into the second housing of the connector apparatus with the switch for improving contact reliability according to the exemplary embodiment of the present disclosure. FIG. 5 is a sectional view illustrating a state in which the connector position assurance member is primarily inserted and the terminal position assurance member is mounted to the second housing of the connector apparatus with the switch for improving contact reliability according to the exemplary embodiment of the present disclosure.

Referring to FIGS. 3 to 5, the connector position assurance member 300 includes an elongated first leg portion 302 inserted into a locking space portion 219 between a surface of the second housing 210 and the elastic lever 230 so as to provide secondary locking of the elastic lever 230 primarily locked to the coupling portion 112a to thereby prevent the elastic lever 230 from being elastically deformed, a head portion 304 formed at an outer side of the first leg portion 302, and an elongated second leg portion 306 having a first side connected to the head portion 304 and a second side inserted into the sliding guide portion 220.

Before the second housing 210 is inserted into the insertion portion 112, the first leg portion 302 is inserted into the locking space portion 219. In this case, a leg coupling portion 302a is formed to protrude from an end of the first leg portion 302 so as to be locked into the first locking space portion 234a. As illustrated in FIG. 5, when the second housing 210 is inserted into the insertion portion 112 in a state in which the leg coupling portion 302a is locked into the first locking space portion 234a, the elastic lever 230 may be elastically deformed downwardly. This will be described later.

When the first leg portion 302 is inserted into the locking space portion 219, the second leg portion 306 is slid along the longitudinal direction of the sliding guide portion 220 in a state of being inserted into the sliding guide portion 220. With this configuration in which the second leg portion 306 is moved along the sliding guide portion 220, there is an effect that a separate support arm for guiding the sliding of the connector position assurance member 300 is not required, making it possible to reduce the overall width of the connector position assurance member 300.

The terminal position assurance member 400 functioning as a terminal position assurance (TPA) to determine the position of the respective second terminals inserted into the second terminal guide portions 222 is mounted to the second housing 210. To this end, a receiving recess 214a is formed in the second surface portion 214 of the second housing 210 to be concave in the direction of the inside of the second housing 210. The sliding guide portion 220 and the second terminal guide portions 222 are configured to be exposed to the outside by the receiving recess 214a. The terminal position assurance member 400 includes a cover portion 402 covering an open lower side of the receiving recess 214a, and a position assurance protrusion 404 protruding from an inner side of the cover portion 402 in the direction of the second terminal guide portions 222. After the second terminals are inserted into the second terminal guide portions 222, when the terminal position assurance member 400 is inserted into the receiving recess 214a, the second terminals are locked to the respective position assurance protrusions 404, thereby determining the position of the second terminals.

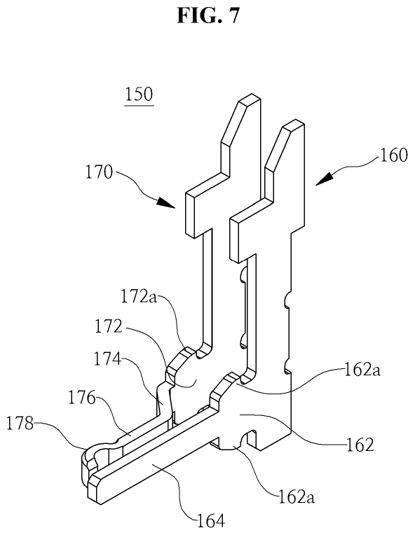

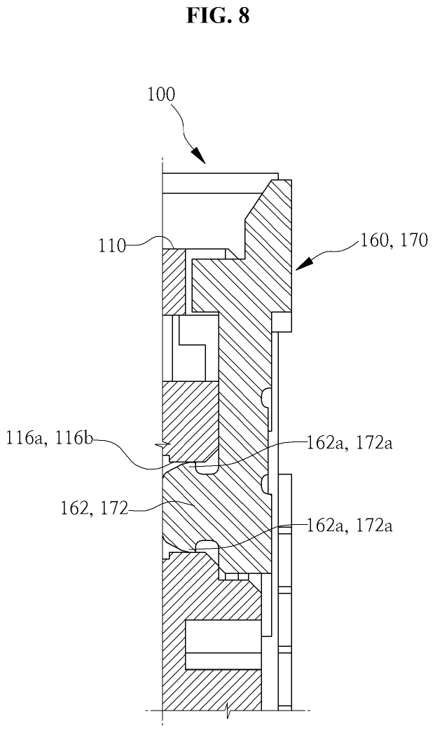

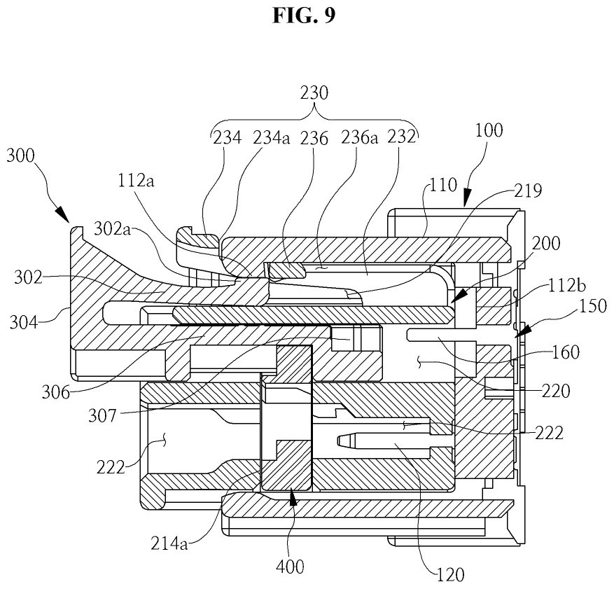

FIG. 6 is a partially cut view illustrating the first housing of the connector apparatus with the switch for improving contact reliability according to the exemplary embodiment of the present disclosure. FIG. 7 is a view illustrating the switch of the connector apparatus with the switch for improving contact reliability according to the exemplary embodiment of the present disclosure. FIG. 8 is a sectional view illustrating a state in which the switch of the connector apparatus with the switch for improving contact reliability according to the exemplary embodiment of the present disclosure is coupled to the first housing.

Referring to FIGS. 6 to 8, the connector position assurance member 300 is mechanically provided to prevent, after the second housing 210 of the second connector 200 is inserted into the insertion portion 112 formed in the first housing 110 of the first connector 100, the disengagement of the first and second connectors 100 and 200. The connector position assurance member 300 has a problem in that it cannot be checked from the outside whether it is properly coupled to the first housing 110. In order to solve this problem, the present disclosure includes the contact guide portion 116 and the switch 150 to electrically test proper coupling of the connector position assurance member 300 and the first housing 110.

The contact guide portion 116 is formed in a hole shape in the vicinity of the center of an inner front side of the insertion portion 112, and is provided as a pair of contact guide portions 116 composed of a first contact guide portion 116a and a second contact guide portion 116b that are positioned to face each other. In this case, a switch receiving recess 112b may be concavely formed at the inner front side of the insertion portion 112 at a position facing the sliding guide portion 220, and the first contact guide portion 116a and the second contact guide portion 116b may be formed through the switch receiving recess 112b.

The switch 150 is provided as a pair of switches 150 composed of a first switch 160 and a second switch 170. The first switch 160 is formed to pass through the first contact guide portion 116a, and includes a first switch insertion portion 162 inserted into the first contact guide portion 116a and a contact portion 164 extending linearly from the first switch insertion portion 162.

The second switch 170 is formed to pass through the second contact guide portion 116b, and includes a second switch insertion portion 172 having a first side connected to an inclined portion 174 which will be described later and a second side inserted into the second contact guide portion 116b, the inclined portion 174 formed to be inclined in the direction of the first switch 160 from the second switch insertion portion 172 passing through the second contact guide portion 116b, an extension portion 176 extending in parallel to the first switch 160 from an end of the inclined portion 174, and a convex contact portion 178 formed at an end of the extension portion 176 to be convex in the opposite direction of the first switch 160. The first and second switch insertion portions 162 and 172 are electrically coupled to a substrate (not illustrated) on which the first housing 110 is mounted.

A switch guide recess 307 is formed at an end of the second leg portion 306 so that when the second leg portion 306 is inserted into the sliding guide portion 220, the first and second switches 160 and 170 are guided and brought into contact with each other. The switch guide recess 307 is formed so that the separation distance between inner opposite sides thereof gradually decreases as the distance from the contact guide portion 116 increases. The switch guide recess 307 includes a receiving portion 308 having an internal space for allowing the first and second switches 160 and 170 to be guided therein, and a receiving side wall portion 309 famed in a wall shape at a side of the receiving portion 308. The receiving side wall portion 309 includes a contact guide wall portion 309a positioned at an inner side of the receiving portion 308, and a sliding inclined portion 309b positioned at an outer side of the receiving portion 308 facing the switch receiving recess 112b and famed inclinedly. When the first switch 160 and the second switch 170 are guided to the switch guide recess 307 as the second leg portion 306 is inserted into the sliding guide portion 220, the first switch 160 and the second switch 170 are brought into contact with each other as the first switch 160 or the second switch 170 is slid along the receiving side wall portion 309 of the switch guide recess 307.

Meanwhile, a first locking protrusion 162a is formed to protrude from each of longitudinal opposite sides of the first switch insertion portion 162 so as to be locked to the inner periphery of the first contact guide portion 116a. A second locking protrusion 172a is formed to protrude from each of longitudinal opposite sides of the second switch insertion portion 172 so as to be locked to the inner periphery of the second contact guide portion 116b. With this configuration in which the first and second locking protrusions 162a and 172a are locked to the first and second contact guide portions 116a and 116b, there is an effect that even if external pressure is applied to the first and second switches 160 and 170, the first and second switches 160 and 170 can be firmly secured to the first and second contact guide portions 116a and 116b.

Hereinafter, the operation of the connector apparatus with the switch for improving contact reliability according to the exemplary embodiment of the present disclosure will be described.

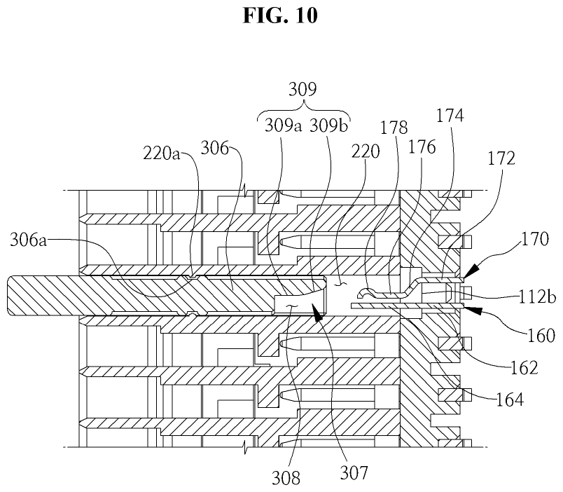

FIG. 9 is a view schematically illustrating an off state of the switch of the connector apparatus with the switch for improving contact reliability according to the exemplary embodiment of the present disclosure. FIG. 10 is a sectional view illustrating an off state of the switch of the connector apparatus with the switch for improving contact reliability according to the exemplary embodiment of the present disclosure.

First, as illustrated in FIG. 5, the first leg portion 302 of the connector position assurance member 300 is half inserted into the locking space portion 219, so that the leg coupling portion 302a is locked into the first locking space portion 234a (CPA primary locking state). Then, the terminal position assurance member 400 is inserted into the receiving recess 214a of the second housing 210.

Thereafter, as illustrated in FIGS. 9 and 10, the second housing 210 is forwardly inserted into the insertion portion 112 of the first housing 110, so that the first connector 100 and the second connector 200 are coupled to each other. The coupling portion 112a is sequentially passed the second locking space portion 236a and the second locking connection portion 236 of the elastic lever 230 and then locked into the first locking space portion 234a. When the coupling portion 112a is locked into the first locking space portion 234a, the coupling portion 112a presses downwardly the leg coupling portion 302a of the connector position assurance member 300 previously locked into the first locking space portion 234a, causing the first leg portion 302 to be elastically deformed downwardly from the first locking space portion 234a. At this time, the second leg portion 306 is in a state of being spaced apart from the first and second switches 160 and 170, so that the first and second switches 160 and 170 are in an off state.

Meanwhile, a position guide portion 306a is concavely formed at each of opposite sides of the second leg portion 306, and a locking guide portion 220a is convexly formed at each of opposite sides of the sliding guide portion 220 so as to allow the position guide portion 306a to be locked thereto in a state in which the second leg portion 306 is partially inserted into the sliding guide portion 220, i.e., the first leg portion 302 is half inserted into the locking space portion 219, and the first leg portion 302 is thereby elastically deformed downwardly from the first locking space portion 234a. With this configuration in which the respective position guide portions 306a are locked to the respective locking guide portions 220a, there is an effect that the second leg portion 306 is prevented from being fully inserted into the sliding guide portion 220 arbitrarily during transport, etc., thereby preventing the off state of the first and second switches 160 and 170 from being changed arbitrarily.

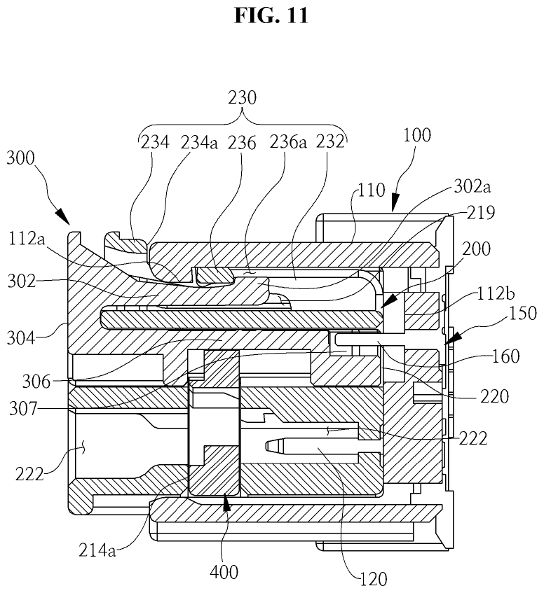

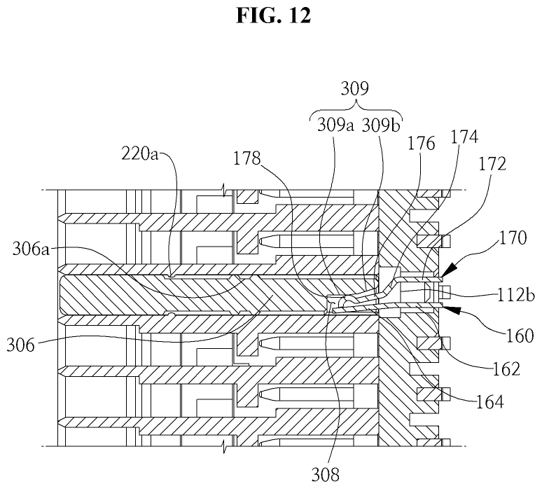

FIG. 11 is a view schematically illustrating an on state of the switch of the connector apparatus with the switch for improving contact reliability according to the exemplary embodiment of the present disclosure. FIG. 12 is a sectional view illustrating an on state of the switch of the connector apparatus with the switch for improving contact reliability according to the exemplary embodiment of the present disclosure.

Referring to FIGS. 11 and 12, when a forward pressure is applied to the head portion 304 after the leg coupling portion 302a is released downwardly from the first locking space portion 234a, the first leg portion 302 is moved forwardly along the locking space portion 219, and the leg coupling portion 302a is passed the second locking connection portion 236 and then locked into the second locking space portion 236a. At this time, the first leg portion 302 is elastically deformed to its original position to lock the leg coupling portion 302a into the second locking space portion 236a (CPA secondary locking state). When the leg coupling portion 302a is locked into the second locking space portion 236a, the elastic lever 230 is not allowed to be moved downwardly, so that the coupling portion 112a is firmly retained in the locked position in the first locking space portion 234a, thereby preventing the first connector 100 and the second connector 200 from being arbitrarily disengaged from each other.

When the first leg portion 302 is moved forwardly along the locking space portion 219, the second leg portion 306 is moved forwardly along the sliding guide portion 220. At this time, when the first switch 160 and the second switch 170 are guided to the switch guide recess 307, the first switch 160 and the second switch 170 are brought into contact with each other as the first switch 160 or the second switch 170 is slid along a side portion of the switch guide recess 307.

In detail, when the first and second switches 160 and 170 are not inserted into the switch guide recess 307 as the second leg portion 306 is half inserted into the sliding guide portion 220, the first switch 160 and the extension portion 176 are positioned to be spaced apart from each other. Therefore, the first and second switches 160 and 170 are in an off state. In this state, when the first and second switches 160 and 170 are inserted into the switch guide recess 307 as the second leg portion 306 is fully inserted into the sliding guide portion 220, the extension portion 176 is slid along the sliding inclined portion 309b and then moved in the direction of the first switch 160, so that the extension portion 176 and the first switch 160 are brought into surface contact with each other, generating an on signal.

When the connector position assurance member 300 is properly coupled to the first housing 110, the second leg portion 306 is fully inserted into the sliding guide portion 220. At this time, as the first and second switches 160 and 170 are inserted into the switch guide recess 307, the extension portion 176 and the first switch 160 are brought into surface contact with each other. The on signal generated upon the contact between the extension portion 176 and the first switch 160 is transmitted to an external substrate. With this configuration, there is an effect that an operator can electrically accurately test whether the connector position assurance member 300 is properly coupled the first housing 110.

In addition, when the connector position assurance member 300 is completely coupled to the first housing 110, the first and second switches 160 and 170 are stably brought into contact with each other in a state of being inserted into the switch guide recess 307 formed in the second leg portion 306. With this configuration, there is an effect that the first and second switches 160 and 170 can be safely protected from foreign substances, etc., thereby improving the contact reliability of the first and second switches 160 and 170.

In addition, the extension portion 176 and the first switch 160 are brought into surface contact with each other and thus have a wide contact area. Therefore, there is an effect that even if foreign substances such as small dust are caught between the extension portion 176 and the first switch 160, the extension portion 176 and the first switch 160 can stably maintain the contact state, thereby further improving the contact reliability.

Meanwhile, when the extension portion 176 is moved in the direction of the first switch 160, the convex contact portion 178 is elastically deformed in the direction of the first switch 160 in a state of being in contact with the contact guide wall portion 309a. With this configuration, there is an effect that the convex contact portion 178 can stably maintain the electrical contact state between the extension portion 176 and the first switch 160.

In addition, the inclined portion 174 is configured to be elastically deformable in the direction of the first switch 160 in a state of being received in the switch receiving recess 112b when the convex contact portion 178 is elastically deformed in the direction of the first switch 160. While the second switch 170 is moved to be brought into contact with the first switch 160, the switch receiving recess 112b provides a space for allowing the inclined portion 174 to be elastically deformed therein. With this configuration, there is an effect that the inclined portion 174 can be easily elastically deformed.

Although the exemplary embodiment of the present disclosure has been described for illustrative purposes, those skilled in the art will appreciate that various modifications, additions, and substitutions are possible, without departing from the scope and spirit of the disclosure as defined in the accompanying claims.

What is claimed is:

1. A connector apparatus with a switch for improving contact reliability, the connector apparatus comprising:
a first connector including a first housing having an insertion portion concavely formed at a first side thereof and a plurality of first guide portions formed through a second side of the first housing in the direction of the insertion portion, wherein among the plurality of first guide portions, any one first guide portion is a contact guide portion, the remaining first guide portion except for the contact guide portion is a first terminal guide portion configured to allow the first terminal to be inserted therein, and a coupling portion is formed to protrude from an inner surface of the insertion portion;
a pair of switches configured to be respectively inserted through a pair of contact guide portions;
a second connector inserted into the insertion portion, and including a second housing having a plurality of second guide portions therein and an elastic lever protruding in a cantilever shape from a surface of the second housing so as to have elasticity, wherein among the second guide portions, a second guide portion facing the pair of contact guide portions is a sliding guide portion, the remaining second guide portion facing the first terminal guide portion is a second terminal guide portion configured to allow the second terminal to be inserted therein, and the elastic lever is elastically deformed and locked to the coupling portion when the second housing is inserted into the insertion portion; and
a connector position assurance member including a first leg portion inserted into a locking space portion between the second housing and the elastic lever so as to prevent the elastic lever locked to the coupling portion from being elastically deformed, a head portion formed at an outer side of the first leg portion, and a second leg portion having a first side connected to the head portion and a second side inserted into the sliding guide portion,
wherein a switch guide recess is formed at an end of the second leg portion so that when the second leg portion is inserted into the sliding guide portion, the first and second switches are guided and brought into contact with each other.

2. The connector apparatus of claim 1, wherein the pair of contact guide portions is composed of a first contact guide portion and a second contact guide portion,
the pair of switches is composed of a first switch and a second switch respectively passing through the first contact guide portion and the second contact guide portion and positioned to be spaced apart from each other,
the switch guide recess is formed so that the separation distance between inner opposite sides thereof gradually decreases as the distance from the contact guide portions increases, and
when the first switch and the second switch are guided to the switch guide recess, the first switch and the second switch are brought into contact with each other as the first switch or the second switch is slid along a side portion of the switch guide recess.

3. The connector apparatus of claim 2, wherein the switch guide recess comprises a receiving portion having an internal space configured to allow the first and second switches to be guided therein, and a receiving side wall portion formed at a side of the receiving portion,
the receiving side wall portion comprises a contact guide wall portion positioned at an inner side of the receiving portion and a sliding inclined portion positioned at an outer side of the receiving portion and formed inclinedly,
the first switch is linearly formed to pass through the first contact guide portion,
the second switch is formed to pass through the second contact guide portion and comprises an inclined portion inclined in the direction of the first switch in a state of and an extension portion extending in parallel to the first switch from an end of the inclined portion,
the first switch and the extension portion are positioned to be spaced apart from each other before the first switch and the second switch are inserted into the switch guide recess, and
when the first switch and the second switch are inserted into the switch guide recess, the extension portion is slid along the sliding inclined portion and then moved in the direction of the first switch, so that the extension portion and the first switch are brought into surface contact with each other.

4. The connector apparatus of claim 3, wherein a convex contact portion is formed at an end of the extension portion to be convex in the opposite direction of the first switch,
wherein when the extension portion is moved in the direction of the first switch, the convex contact portion is elastically deformed in the direction of the first switch in a state of being in contact with the contact guide wall portion, so that the convex contact portion maintains an electrical contact state between the extension portion and the first switch.

5. The connector apparatus of claim 3, wherein a switch receiving recess is concavely formed at an inner side of the insertion portion at a position facing the sliding guide portion, wherein the first contact guide portion and the second contact guide portion are formed through the switch receiving recess, and
the inclined portion is configured to be elastically deformable in a state of being received in the switch receiving recess.

6. The connector apparatus of claim 2, wherein the first switch comprises a first switch insertion portion inserted into the first contact guide portion and a contact portion extending linearly from the first switch insertion portion, wherein a first locking protrusion is formed to protrude from each of longitudinal opposite sides of the first switch insertion portion so as to be locked to an inner periphery of the first contact guide portion, and
the second switch further comprises a second switch insertion portion having a first side connected to the inclined portion and a second side inserted into the second contact guide portion, wherein a second locking protrusion is famed to protrude from each of longitudinal opposite sides of the second switch insertion portion so as to be locked to an inner periphery of the second contact guide portion.

7. The connector apparatus of claim 1, wherein a position guide portion is formed at each of opposite sides of the second leg portion, and a locking guide portion is formed at each of opposite sides of the sliding guide portion so as to allow the position guide portion to be locked thereto in a state in which the second leg portion is partially inserted into the sliding guide portion.
